(19) United States
(12) Patent Application Publication
(10) Pub. No.: US 2001/0030494 A1
(43) Pub. Date: Oct. 18, 2001

(54) Ground electrode for spark plug, spark plug and method of manufacturing the same

(76) Inventor: Keiji Kanao, Chita-gun (JP)

Correspondence Address: Pillsbury, Madison & Sutro, LLP, East Tower, 1100 New York Avenue, N.W., Ninth Floor, Washington, DC, 20005-3918, US

(21) Appl. No.: 09/766,404

(22) Filed: Jan. 22, 2001

(30) Foreign Application Priority Data
Jan. 24, 2000 (JP) 2000-17960

(51) Int. Cl. H01T 21/02; H01T 13/20

(52) U.S. Cl. 313/141; 445/7

(57) ABSTRACT

In a method of manufacturing a ground electrode for spark plug having a better heat conductive core metal such as Cu, Cu alloy or composite metal of Cu and Ni and a better erosion and oxidization resistant coating metal, a composite body of the core and coating metals in which an outer circumference of the core metal with the coating metal is wrapped with the coating metal and an end of the core metal is completely embedded into the coating metal on an end side thereof is prepared. Then, the composite body is cut to form a bar type body having a predetermined length from the end of the coating metal. Simultaneously, the bar type body on a cut end side thereof is formed in each of the core and coating metals to have a narrow portion whose cross sectional area is reduced during a given length thereof extending up to each another end of the core and coating metals.

### CROSS REFERENCE TO RELATED APPLICATION

This application is based upon and claims the benefit of priority of Japanese Patent Application No. 2000-17960 filed on Jan. 24, 2000, the content of which is incorporated herein by reference.

### BACKGROUND OF THE INVENTION

1. Field of the Invention

The present invention relates to a ground electrode for a spark plug composed of a coating metal having better erosion and oxidization resistance and a core metal, whose heat conductivity is better than that of the coating metal, wrapped with the coating metal member, a spark plug having the ground electrode mentioned above, and a method of manufacturing the same. The spark plug is applicable, for example, to an internal combustion engine for a vehicle, a cogeneration and a pump for supplying pressurized gas.

2. Description of Related Art:

When a spark plug is used under a heavy heat load environment, temperature of a ground electrode thereof is likely to increase and exceed a temperature endurance limit. Therefore, to promote better heat dissipation of the ground electrode not to increase so much electrode temperature thereof, known is a ground electrode for a spark plug in which a core metal having relatively higher heat conductivity, such as Cu, Cu alloy or composition of Cu and Ni, is wrapped with a coating metal having better erosion and oxidization resistance, such as Ni alloy.

However, the conventional ground electrode has a drawback that, if the core metal having higher heat conductivity is exposed out of the coating metal after welding the ground electrode to a housing, the core metal is likely to be oxidized and eroded during its use in a combustion chamber of the internal combustion engine, since the metal having better heat conductivity has poorer erosion resistance, and, accordingly, the ground electrode is likely to come off the housing.

To cope with the problem mentioned above, a manufacturing method disclosed in JP-A-2-312176 is known. According to this method, an end of the core metal is primly wrapped with the coating metal before a composite body of the core and coating members is welded to the housing so that the exposure of the core member after the welding is prevented. However, this method has complicated processes and becomes higher at cost since a periphery of the coating member on a side of an opening end thereof is bent and caulked by a forming die to completely wrap the end of the core member.

### SUMMARY OF THE INVENTION

An object of the present invention is to provide a ground electrode for a spark plug in which a core metal is wrapped with a coating metal at a cheaper cost so that an exposure of the core metal after welding is prevented.

To achieve the object, an outer circumference of the core metal is wrapped with the coating metal and an end thereof is completely embedded into the coating metal on an end side thereof. Further, each of the core and coating metal has a narrow portion whose cross sectional area is reduced during a given length thereof extending up to each another end of the core and coating metals.

An end of the ground electrode on a side of the narrow portion thereof is bonded by welding to a housing. Even if a bonding position of the ground electrode to the housing is radially offset, the core metal does not expose out of the coating metal after welding and debarring because of the narrow portion whose cross sectional area is reduced during the given length thereof extending up to each another end of the core and coating metals.

It is preferable that the cross sectional area of the narrow portion is smaller toward the each another end of the core and coating metals so that the narrow portion is formed in tapered shape. Preferably, a tapered angle of the narrow portion is 15° or more.

With this taper shaped narrow portion, even if the another end of the core metal exposes out of the coating metal before welding, the another end of the coating metal is bonded by welding to the housing so that, at a boding portion, a center part of the another end of core metal comes in close contact with the housing and a part of the coating metal is curved inside to hold an entire circumferential periphery of the another end of the core metal. Accordingly, the core metal never exposes after welding.

Preferably, a length of the coating metal curved inside to hold the circumferential periphery of the another end of the core metal member is 0.1 mm or more.

It is another object to provide a method of manufacturing a ground electrode for a spark plug having the distinctive feature mentioned above.

To achieve the another object, the method comprises steps of, at first, forming a composite body of the core and coating metals in which an outer circumference of the core metal is wrapped with the coating metal and an end of the core metal is completely embedded into the coating metal on an end side thereof. Then, the composite body is cut to form a bar type body having a predetermined length from the end of the coating metal. Finally, the bar type body on a cut end side thereof is formed so that each of the core and coating metals has a narrow portion whose cross sectional area is reduced during a given length thereof extending up to each another end of the core and coating metals.

The bar type body mentioned above constitutes the ground electrode to be bonded by welding to the housing.

It is a further object to provide a spark plug having the ground electrode that has distinctive features mentioned above or to provide a method of manufacturing the spark plug.

### BRIEF DESCRIPTION OF THE DRAWING

Other features and advantages of the present invention will be appreciated, as well as methods of operation and the function of the related parts, from a study of the following detailed description, the appended claims, and the drawings, all of which forma part of this application. In the drawings:

FIG. 1 is a schematic cross sectional view showing a ground electrode bonded to a housing for a spark plug according to an embodiment of the present invention;

FIG. 2A is a view showing a first step of a method of manufacturing the ground electrode of FIG. 1;

FIG. 2B is a view showing a second step of the method of manufacturing the ground electrode of FIG. 1;

FIG. 2C is a view showing a third step of the method of manufacturing the ground electrode of FIG. 1;

FIG. 2C1 is a view of the ground electrode as viewed from an arrow IIRC1 of FIG. 2C;

FIG. 2D is a view showing a fourth step of the method of manufacturing the ground electrode of FIG. 1;

FIG. 2D1 is a view of the ground electrode as viewed from an arrow IID1 of FIG. 2D;

FIG. 2E is a view showing a fifth step of the method of manufacturing the ground electrode of FIG. 1;

FIG. 2F is a view showing a sixth step of the method of manufacturing the ground electrode of FIG. 1;

FIG. 3A is a cross sectional part view of the ground electrode and the housing before welding;

FIG. 3B is a cross sectional part view of the ground electrode and the housing after welding;

FIG. 4A is a cross sectional part view of the ground electrode placed at a normal position relative to the housing before welding;

FIG. 4B is a cross sectional part view of the ground electrode of FIG. 4A bonded to the housing after welding;

FIG. 4C is a cross sectional part view of the ground electrode placed at an offset position relative to the housing before welding;

FIG. 4D is a cross sectional part view of the ground electrode of FIG. 4C bonded to the housing after welding;

FIG. 4E is a cross sectional part view of the ground electrode and the housing of FIG. 4D after debarring;

FIG. 5A is a cross sectional part view of the ground electrode before being formed in tapered shape;

FIG. 5B is a cross sectional part view of the ground electrode after being formed in tapered shape;

FIG. 6 is a graph showing a relationship between bonding strength and taper angle θ;

FIG. 7A is a schematic cross sectional view showing a part of coating metal curved inside to hold circumferential periphery of core metal;

FIG. 7B is a graph showing a relationship between a length of the coating length curved inside and the taper angle θ;

FIG. 8A is a view showing a modified method of manufacturing the ground electrode of FIG. 1;

FIG. 8B is a view of the ground electrode after the method of FIG. 8A;

FIG. 9A is a view a first step of another modified method of manufacturing the ground electrode of FIG. 1;

FIG. 9B is a view a second step of the another modified method of manufacturing the ground electrode of FIG. 1; and

FIG. 9C is a view of the ground electrode after the method of FIG. 9B.

### DETAILED DESCRIPTION OF THE PREFERRED EMBODIMENTS

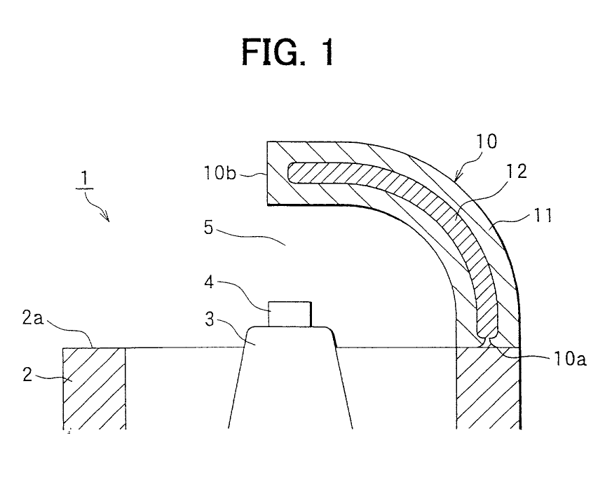

FIG. 1 shows a ground electrode 10 for spark plug 10 according to an embodiment of the present invention. The ground electrode 10 is bonded to an end 2a of a cylindrical housing 2 of a spark plug 1. The housing 10 is made of low carbon steel.

An insulator 3 is fixed to an inside of the housing 2. A center electrode 4 is fixed to the insulator 3 so that an end thereof is exposed out of the insulator. The insulator 3 is made of, for example, alumina ceramics (Al₂O₃) and the center electrode 4 is made of, for example, a composite body of core metal having relatively higher heat conductivity such as Cu and coating metal having better heat and erosion resistance such as Ni base alloy.

A ground electrode 10 is formed in letter L stick shape. An end 10b of the ground electrode 10 faces the center electrode 4 held by the insulator 3 to constitute a spark gap therebetween. The other end 10a of the ground electrode 10 is bonded by welding to an end 2a of the housing 2. The ground electrode 10 has a construction that core metal having relatively higher heat conductivity, such as Cu or Cu alloy, is wrapped with coating metal having better erosion and oxidization resistance, such as Ni alloy.

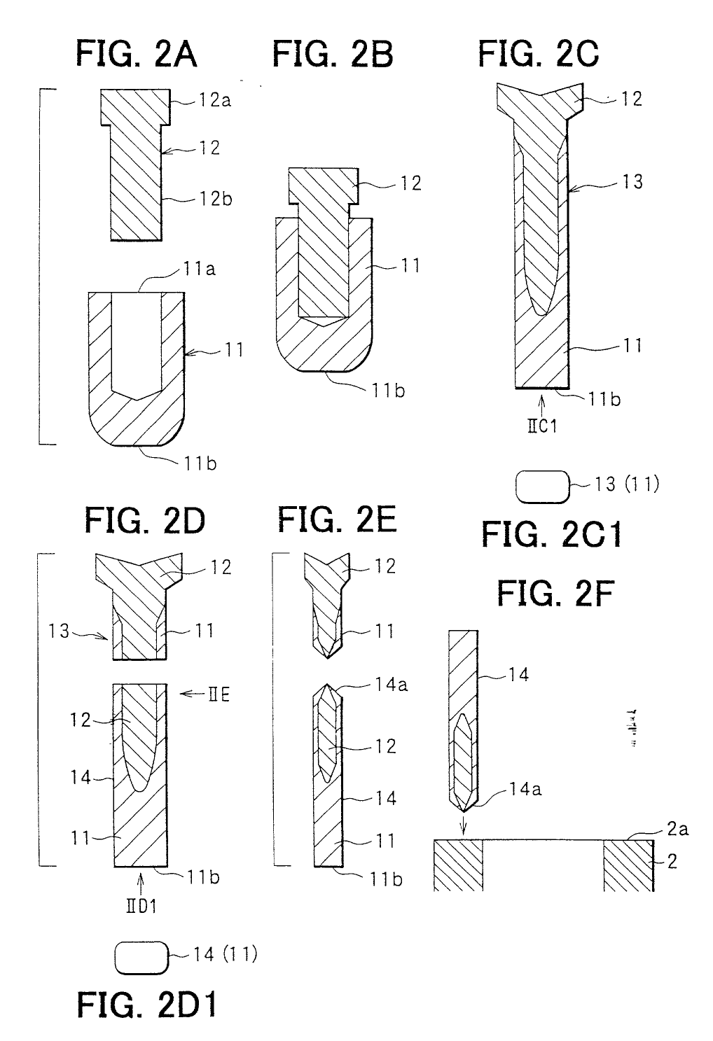

A method of manufacturing the spark plug 1 incorporating the ground electrode is described with reference to FIGS. 2A to 2 F. As shown in FIG. 2A, a core member (metal) 12 and a cup shaped coating member (metal) are prepared. The core member 12 is formed by cold forging to have a large diameter head portion 12a and a small diameter rod portion 12b. The coating member 11 is formed by cold forging to have an opening end 11a and a closing end 11b.

Next, as shown in FIG. 2B, the rod portion 12b of the core member 12 is inserted from the opening end 11a into the coating member 11 and, then, the head portion 12a of the core member 12 is pressed against the coating member 11 toward the closing end 11b so that the core and coating members 12 and 11 are integrated (integration process).

Next, the integrated body of the core and coating members 12 and 11 is extruded in use of an extrusion die (not shown) so that the ground electrode is formed in straight rod shape as shown in FIG. 2C, not in a letter L shape shown in FIG. 1. The ground electrode 10 according to the present embodiment, as shown in FIG. 2C1, is shaped as a square pillar (for example, having 1.6 mm×2.8 mm cross sectional area). The straight rod of the ground electrode 10 after the extrusion process constitutes a composite body 13 of the core and coating members 12 and 11.

As a next step shown in FIG. 2D, the composite body 13 is cut to a predetermined length by a cutter (not shown). After cutting the composite body 13 into two pieces, one piece on a side of the closing end 11b constitutes a bar type body 14. The bar type body 14, as shown in FIG. 2D1, is shaped as a square pillar.

Then, the bar type body 14 is radially pressed in use of a tool or a jig(not shown) to have a narrow portion whose cross sectional area is reduced during a given length extending up to a cut end 14a (cutting and narrow portion forming processes), as shown in FIG. 2E. The bar type body 14 having the narrow portion mentioned above constitutes the ground electrode 10 for spark plug 1.

The bar type body 14 has a construction that an end of the core member 11 is completely embedded into the coating member 11 on a side of an end 11b thereof (closed end), another end of the core member 11 exposes out of the coating member 11 on a side of the end 14a thereof (cut end side), and the cross sectional area of the narrow portion is smaller toward the end 14a thereof so that the narrow portion is formed in tapered shape.

Next, the end 14a of the bar type body 14 on a side of the narrow portion (corresponding to the other end 10a of the ground electrode 10) is bonded by welding to the end 2a of the housing 2, as shown in FIG. 2F. Then, the bar type body 14 is bent to form a letter L shape so that the ground electrode 10 fixed to the housing 2, as shown in FIG. 1, is completed.

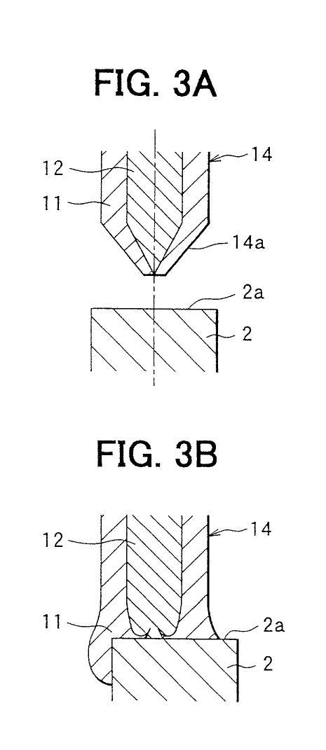

FIGS. 3A and 3B show a method of welding the bar type body 14 of the ground electrode 10. As shown in FIG. 3A, the end 14a of the bar type body 14 on a side of the narrow portion is set to face the end 2a of the housing 2 for welding.

After welding, the narrow portion is molten and a circumference of the end 14a is bonded to the housing to form a bonding portion in which a part of the coating member 11 is curved or bent inside to hold an entire circumferential periphery of the end of the core member 12 and a center part of the end of the core member 12 comes in close contact with the end 2a of the housing 2. As the circumference of the end 14a is completely welded, the core member 12 does not expose out of the coating member 11 after welding, whether or not the end of the core member 12 exposes out of the coating member 11 before welding.

It is preferable that a thickness of the coating member 11 is 0.3 mm or more in view of spark consumption or oxidized consumption. As the thickness of the coating metal 11 is thicker, the exposure of the core member 12 at the bonding portion is more effectively prevented. However, if the thickness of the coating member 11 is too thick, a volume of the core member 12 wrapped with the coating member 11 becomes less so that electrode temperature may not be sufficiently reduced. Accordingly, the thickness of the coating metal 11 is, preferably, 0.5 mm or less. As a result, a preferable range of the thickness of the coating metal 11 is 0.3 to 0.5 mm in view of its manufacturing fluctuation.

Next, a test result of a tapered angle of the narrow portion on the bar type body 14 having Ni base alloy coating member 11 and better heat conductive Cu core member 12 is described. The test is conducted under a condition that the thickness of the coating member 11 of the bar type body 14 is 0.3 mm, which is a lower limit of the preferable range and poorer for preventing the core member 12 from exposing after welding. For a comparison purpose, the test is conducted also on a conventional ground electrode in which the bar type body 14 does not have the narrow portion mentioned above and the end thereof is shaped flat.

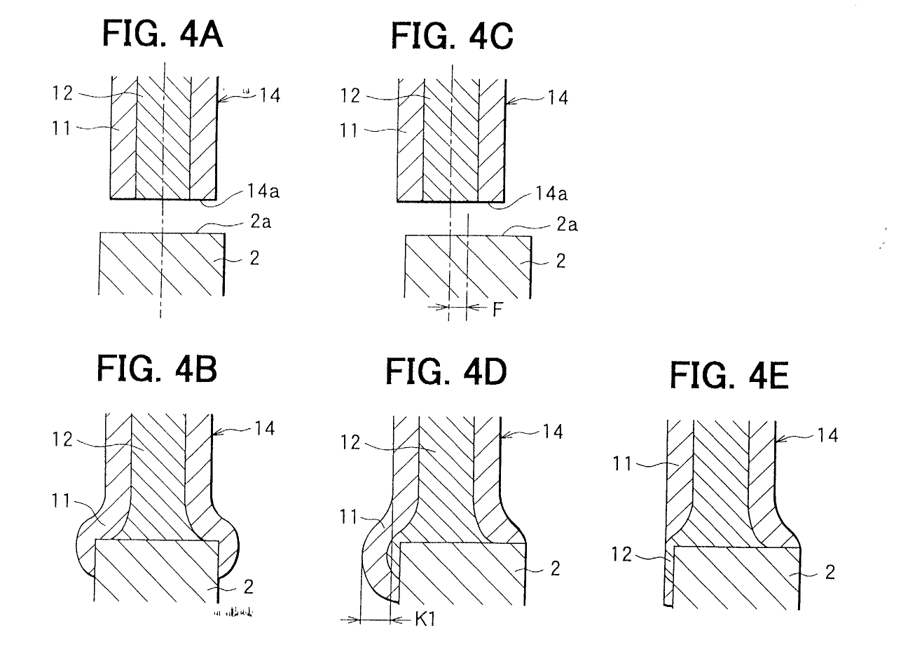

The conventional ground electrode is generally welded, as shown in FIG. 4A and 4B. However, it usually occurs on welding, as shown in FIGS. 4c and 4D, that a position of the ground electrode relative to the housing 2 is offset by a length F. A maximum of the off set length F, which is inevitable on manufacturing, is about 0.2 mm. When the position of the ground electrode relative to the housing 2 is offset as mentioned above, not only the coating member 11 but also the core member 12 result in partly protruding radially outside the end 2a of the housing 2 after welding so that an entire circumference of the coating member 11 at the bonding portion may not position on the end 2a of the housing 2.

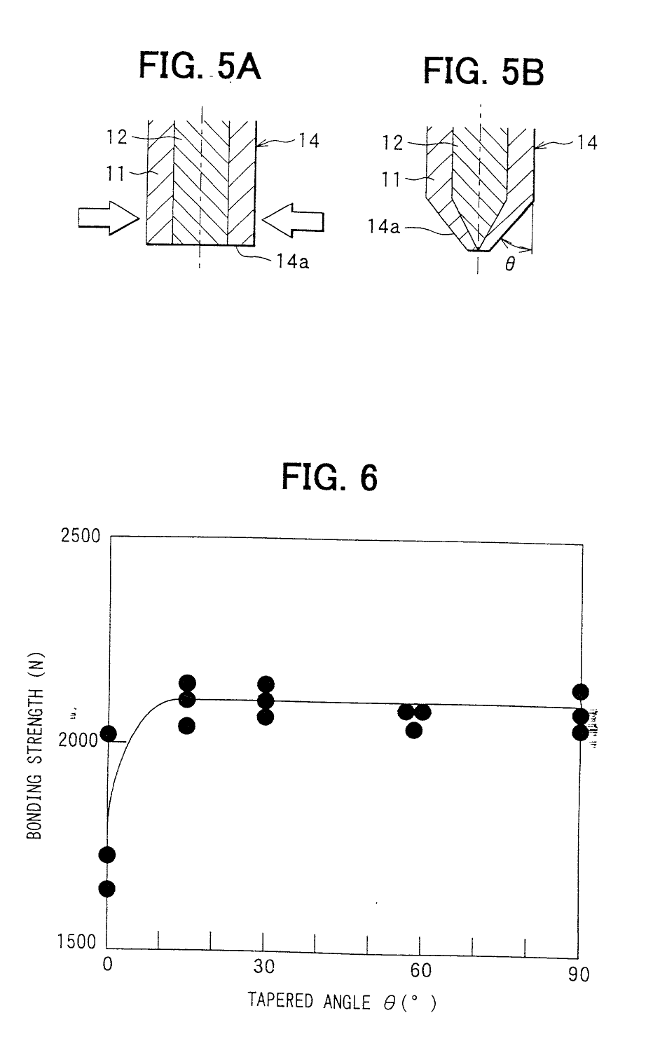

Generally, portions of the coating and core member 11 and 12 protruding outside the housing 2 are presumed as unnecessary welding bars. Therefore, if the welding bars are removed by a length K1, the core member 12 exposes as shown in FIG. 4E. As a result, the ground electrode is likely to come off the housing 2 due to oxidized corrosion. However, as the ground electrode according to the present embodiment has the narrow portion on the end thereof, the core member 12 does not protrude outside the end 2a of the housing 2 after welding and never exposes outside after debarring. In addition to the exposure of the core member due to the offset length F, another experimental test is conducted as shown in FIGS. 5A, 5B and 6 with respect to a relationship between the tapered angle θ of the narrow portion and bonding strength. The tapered angle θ is an inclination angle of the tapered surface to an axis of the bar type body 14.

To manufacture test samples having the tapered surface, after cutting the composite body 13 to a given length, load is applied from opposite sides to the outer circumference of the composite body 13 within a predetermined length from the cut end 14a thereof as shown by arrows of FIG. 5A. By adjusting a value of the load applied thereto, the samples having various values of tapered angle θ are prepared. An axial length of the tapered surface is, for example, 0.1 mm or less that is a molten length of welding in consideration that, if the tapered surface is left after welding, a cross sectional area of the bonding portion becomes smaller and a strength of the ground electrode itself becomes weaker.

The boding strength of the bonding portion is investigated by a well known tensile test. The tensile test is to measure a break down strength and to observe a break down portion with respect to the samples in such a way that both ends of the housing 2 and the ground electrode 10 are held and pulled by a tensile tester. The test result proves that, unless an entire circumference of the coating member 11 is completely bonded onto the end 2a of the housing 2, tensile strength of the boding portion is weaker than an original strength of the ground electrode itself and a boundary of the housing 2 and the ground electrode 10 is broken down.

FIG. 6 shows a graph illustrating the relationship between the tapered angle θ (°) and the bonding strength as tensile strength (N) in a case that the offset length of the ground electrode to the housing is 0.2 mm. As shown in FIG. 6, the bonding strength is sufficient in spite of the offset of the ground electrode, as far as the tapered angle θ exceeds 15°. If the tapered angle θ is less than 15°, the bar type body 14 at a cut end 14a thereof is shaped nearly flat and like the conventional ground electrode. Accordingly, the entire circumference of the coating member 12 at the bonding portion is not completely bonded so that the tensile strength is weaker, while the core member 12 is more likely to expose after removing the welding bars.

In the method of manufacturing the ground electrode for spark plug in which the core metal is wrapped with the coating metal according to the embodiment mentioned above, the conventional process of wrapping the end of the core metal with the coating metal, which is separately provided, is not necessary. Instead, by providing the narrow portion (or the taper portion) in the bar type body 14 simultaneously when or after the composite body 13 is cut, the core metal is prevented from exposure after welding and a sufficient bonding strength of the ground electrode 10 may be secured at lower cost, even if the core metal 12 exposes out of the coating metal before welding and bonded by welding in a state that the position of the ground electrode relative to the housing is offset.

Further, according to the present embodiment, as shown in FIGS. 1 and 3B, the end of the coating metal is curved inside to hold the circumferential periphery of the end of the core metal at the bonding portion where the ground electrode 10 and the housing 2 is welded. The manufacturing method mentioned above makes it possible to form the construction that the coating metal curved inside. The construction serves to further prevent the core metal from exposing outside after welding.

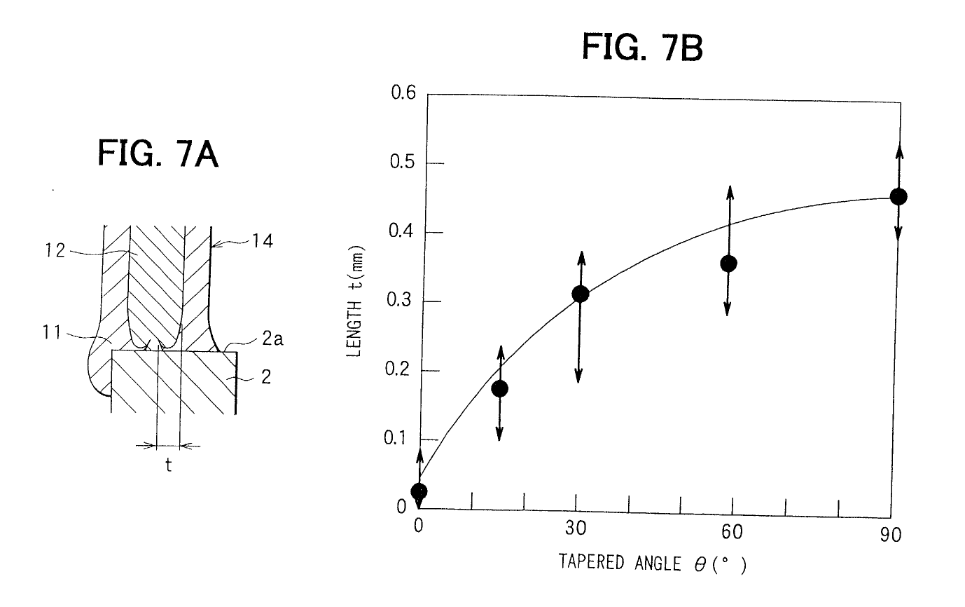

It is preferable that a length t of the coating metal 11 curved inside to hold the circumferential periphery of the core metal 12 is 0.1 or more, as shown in FIGS. 7A and 7B. This is proved by a further experimental test in which each length t (mm)of the coating metal on test samples of the bar type body 14 having various tapered angles θ(°) is measured after welding based on the manufacturing method mentioned above. 5 pieces (n=5) of the bar type bodies 14 having respectively different tapered angles θ are prepared and the length t is measured at 10 points in each piece of the bar type bodies 14. As a result, FIG. 7B shows a relationship between the length t of the coating metal and the tapered angle θ.

It is concluded from the graph shown in FIG. 7B that, in spite of the offset position of the ground electrode to the housing, the ground electrode having the tapered angle θ=15° or more may be provided with the length t of the coating metal curved inside that is larger than 0.1 mm. That is, in the ground electrode having the length t=0.1 mm or more, a sufficient bonding strength may be secured in spite of the offset of the ground electrode to the housing in the welding process.

(Other embodiments)

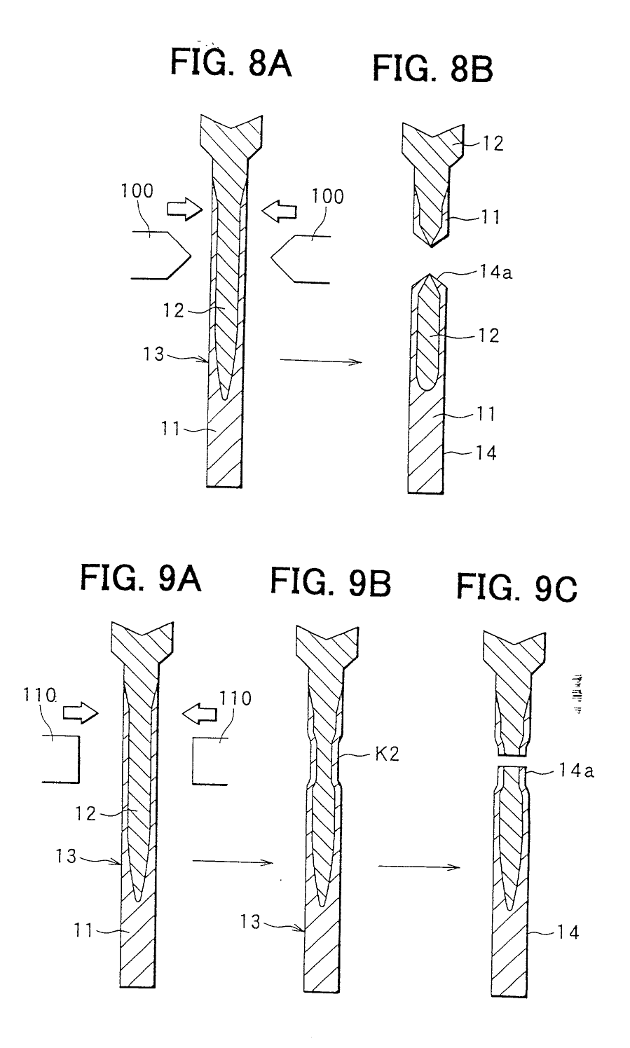

Instead of forming the taper surface of the narrow portion in the bar type body 14 after cutting the composite body 13 by applying load from outside opposite end sides with the tool or the jig, a taper surface in the bar type body 14 shown in FIG. 8B may be formed simultaneously when the composite body 13 is cut in use of a cutting edge (cutter tool) 100 that has a predetermined shape, as shown in FIG. 8A (as a modification).

Further, instead of the tapered surface of the narrow portion whose cross sectional area is smaller toward the end of the bar type body 14, a narrow portion of the bar type body 14 shown in FIG. 9C may be formed, at first, by providing a small diameter portion K2 shown in FIG. 9B, which is formed by applying load with a jig 110 as shown in FIG. 9A, and, then, by cutting the small diameter portion K2 into 2 pieces (another modification). The narrow portion thus made has a cross section whose area is reduced during a given length from the cut end 14a of the bar type body 14. These modifications have same effect as the embodiment mentioned above.

Furthermore, instead of forming the composite body 13 having the final shape (straight rod body) of the ground electrode 10 by extruding the integrated body of the core and coating metal 12 and 11 in the composite body forming process, the final shape (length and thickness of the straight rod body) of the ground electrode 10 may be formed by further extruding the bar type body 14 after cutting the composite body 13.

What is claimed is:

1. A ground electrode for a spark plug comprising;
a coating metal having better erosion and oxidization resistance; and
a core metal whose heat conductivity is higher than that of the coating metal, whose outer circumference is wrapped with the coating metal member and whose one end is completely embedded into the coating metal on an end side thereof,
wherein each of the core and coating metals has a narrow portion whose cross sectional area is reduced during a given length thereof extending up to each another end of the core and coating metals.

2. A method of manufacturing a ground electrode for a spark plug, which has a coating metal having better erosion and oxidization resistance and a core metal whose heat conductivity is higher than that of the coating metal, comprising steps of:
forming a composite body of the core and coating metals in which an outer circumference of the core metal with the coating metal is wrapped with the coating metal and an end of the core metal is completely embedded into the coating metal on an end side thereof;
cutting the composite body to form a bar type body having a predetermined length from the end of the coating metal; and
forming the bar type body on a cut end side thereof so that each of the core and coating metals has a narrow portion whose cross sectional area is reduced during a given length thereof extending up to each another end of the core and coating metals.

3. A method of manufacturing a ground electrode for a spark plug according to claim 2, wherein the cross sectional area of the narrow portion is smaller toward the each another end of the core and coating metals so that the narrow portion is formed in tapered shape.

4. A method of manufacturing a ground electrode for a spark plug according to claim 3, wherein a tapered angle of the narrow portion is 15° or more.

5. A spark plug comprising:
a housing;
a center electrode housed in and insulated from the housing; and
a ground electrode comprising a coating metal having better erosion and oxidization resistance and a core metal whose heat conductivity is higher than that of the coating metal, whose outer circumference is wrapped with the coating metal, and whose end is completely embedded into the coating metal on an end side thereof, an end of the ground electrode being welded to the housing to form a bonding portion so that the center electrode and another end of the ground electrode faces each other with a discharge gap therebetween,
wherein another end of the coating metal is welded to the housing so that, at the bonding portion, a center part of the another end of the core metal comes in close contact with the housing and a part of the coating metal is curved inside to hold a circumferential periphery of the another end of the core metal.

6. A spark plug according to claim 5, wherein a length of the coating metal curved inside is 0.1 mm or more.

7. A method of manufacturing a spark plug having a housing,
a center electrode housed in and insulated from the housing, and
a ground electrode comprising a coating metal having better erosion and oxidization resistance and a core metal whose heat conductivity is higher than that of the coating metal, an end of the ground electrode being bonded to the housing so that the center electrode and another end of the ground electrode faces each other with a discharge gap therebetween, comprising steps of:
forming a bar type body of core and coating metals in which an outer circumference of the core metal with the coating metal is wrapped with the coating metal, an end of the core metal is completely embedded into the coating metal on an end side thereof, and each of the core and coating metals has a narrow portion whose cross sectional area is reduced during a given length thereof extending up to each another end of the core and coating metals; and
bonding by welding an end of the bar type body on a side of the narrow portion to the housing.

8. A method of manufacturing a spark plug according to claim 7, wherein the bar type body is formed by,
forming an composite body of core and coating metals in which the outer circumference of the core metal with the coating metal is wrapped with the coating metal and the end of the core metal is completely embedded into the coating metal on an end side thereof;
cutting the composite body to form the bar type body having a predetermined length from the end of the coating metal; and
forming the bar type body on a cut end side thereof to have the narrow portion.

9. A method of manufacturing a spark plug according to claim 8, wherein the cross sectional area of the narrow portion is smaller toward the each another end of the core and coating metals so that the narrow portion is formed in tapered shape.

10. A method of manufacturing a spark plug according to claim 9, wherein a tapered angle of the narrow portion is 15° or more.
